(19) United States
(12) Patent Application Publication
(10) Pub. No.: US 2010/0018364 A1
(43) Pub. Date: Jan. 28, 2010

(54) QUICK ADJUSTING MULTI-POSITION PLIERS

(75) Inventors: Thomas M. Chervenak, Stanley, NC (US); David P. Engvall, Stanley, NC (US)

Correspondence Address: MOORE & VAN ALLEN PLLC, P.O. BOX 13706, Research Triangle Park, NC, 27709, US

(73) Assignee: IRWIN INDUSTRIAL TOOL COMPANY, Huntersville, NC (US)

(21) Appl. No.: 12/180,839

(22) Filed: Jul. 28, 2008

(51) Int. Cl. B25B 7/04

(52) U.S. Cl. 81/413; 81/391

(57) ABSTRACT

A first member defines an aperture between the jaw and the handle that is defined by a first side wall and a second side wall where the first side wall, second side wall and handle may be integrally formed as a unitary piece. The jaws may also be formed integrally with the handle and side walls. The second member includes an elongated slot and a row of teeth. A pivot member extends along the axis of rotation and includes a tooth engageable with the row of teeth. The pivot member moves between a first position where the teeth are engaged and movement of the first jaw away from the second jaw is prevented and a second position where the teeth are disengaged and movement of the first jaw away from the second jaw is permitted.

The invention relates to pliers and, more particularly, to a quick adjusting pliers that is easy to use, simple to manufacture and has a streamlined profile.

### BACKGROUND OF THE INVENTION

Pliers are known for gripping articles and for applying a turning force to an article. Pliers typically comprise a pair of members pivoted to one another for relative movement. One end of the members include jaws for gripping the article and the other end of the members are formed as handles for manually applying a gripping force to the jaws and a turning force to the pliers. Mechanisms are known for adjusting the distance between the jaws to allow the jaws to grip articles of varying size. One type of mechanism allows the user to push a button to release the engagement of the members from one another and to allow the jaws to be moved relative to one another to adjust the spacing. An example of such pliers is shown in U.S. Pat. No. 7,040,201.

An improved quick adjusting pliers is desired.

### SUMMARY OF THE INVENTION

The pliers comprise a first member having a first jaw at one end and a first handle at an opposite end and a second member having a second jaw at one end and a second handle at an opposite end where the second member pivots relative to the first member at an axis of rotation. The first member defines an aperture for receiving the second member. The aperture is formed between the jaw and the handle and is defined by a first side wall and a second side wall where the first side wall, second side wall and handle may be integrally formed as a unitary piece. The jaws may also be formed integrally with the handle and side walls. The first side wall defines a first hole and the second side wall defines a second hole where the holes are aligned along the axis of rotation. The second member includes an elongated slot and a row of teeth that allows adjustment of the pliers. The second member is located in the aperture such that the elongated slot is aligned with the axis of rotation. A pivot member extends through the holes along the axis of rotation and includes at least one tooth engagable with the row of teeth. The pivot member moves between a first position where the at least one tooth engages the row of teeth and movement of the first jaw away from the second jaw is prevented a second position where the at least one tooth is disengaged from the row of teeth and movement of the first jaw away from the second jaw is permitted. A spring biases the pivot member to the first position. A manually movable actuator button moves the pivot member to the second position.

### BRIEF DESCRIPTION OF THE DRAWINGS

FIG. 1 is a perspective view of one embodiment of the pliers of the invention.

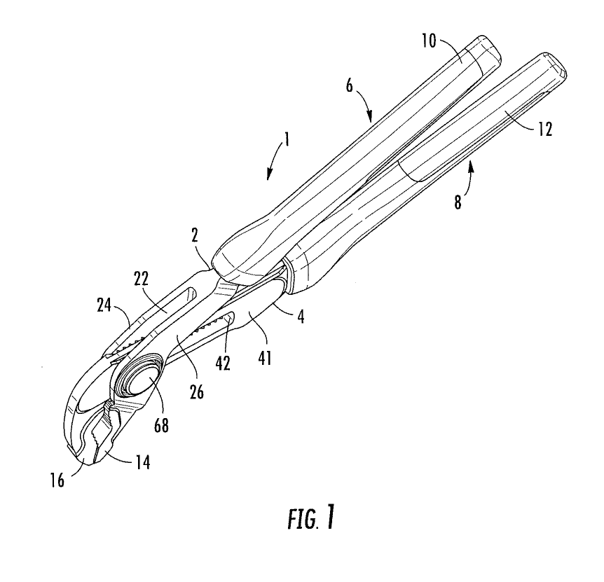

FIG. 2 is an exploded view of the pliers of FIG. 1.

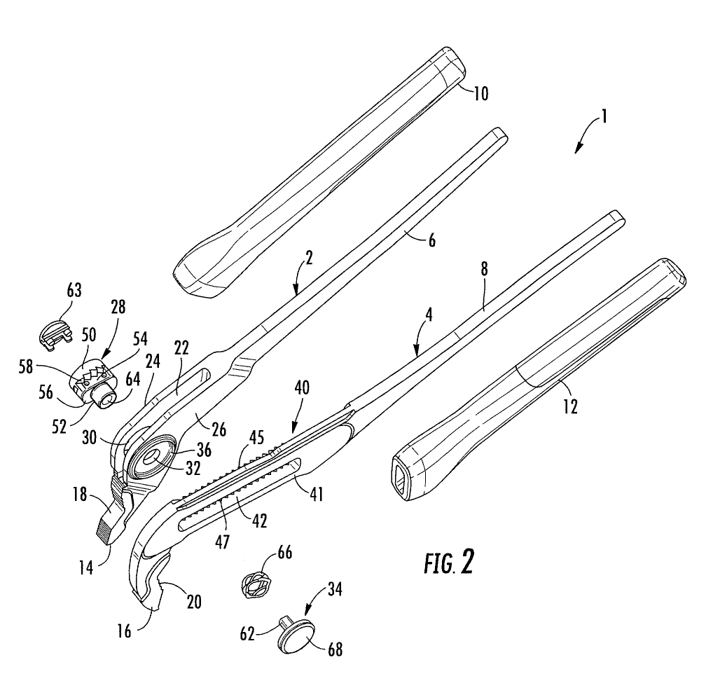

FIG. 3 is a section view of the pliers of FIG. 1.

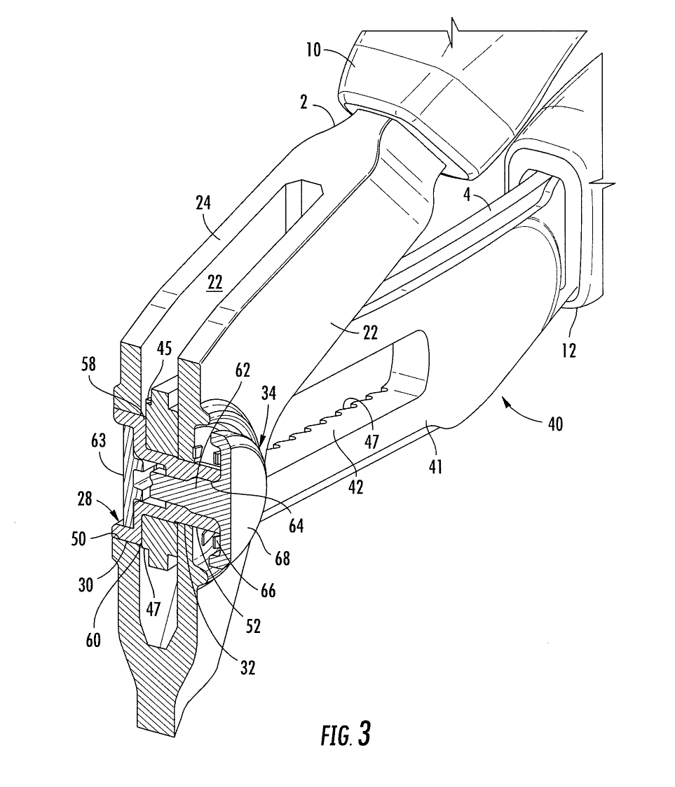

FIG. 4 is a section view taken substantially perpendicular to the section view of FIG. 3.

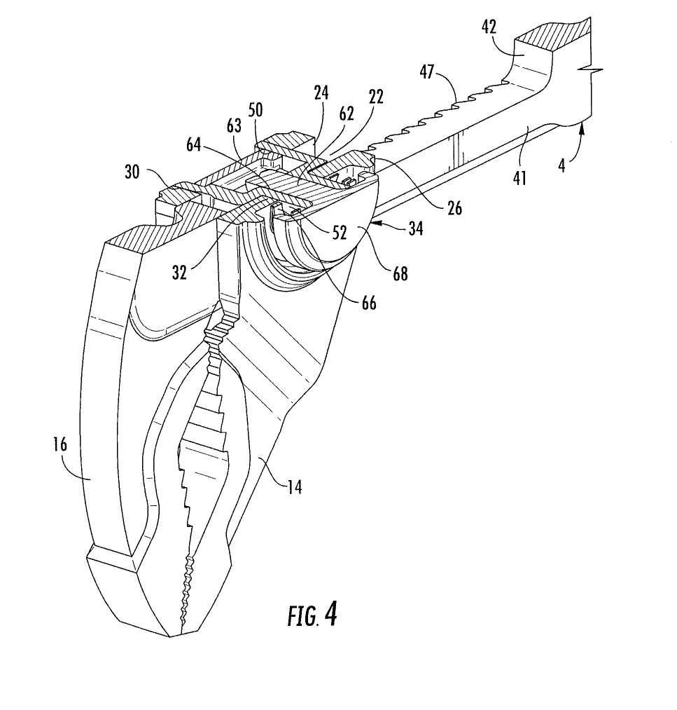

### DETAILED DESCRIPTION OF PREFERRED EMBODIMENTS OF THE INVENTION

The pliers are shown generally at 1 comprising a first member 2 and a second member 4 formed of a rigid material such as heat treated steel. One end of member 2, is formed as a handle 6 to be gripped by a user during use of the pliers. Likewise, one end of member 4 is formed as a handle 8 that is disposed opposite to handle 6 such that the handles can be gripped in the hand of a user to close the jaws and apply a clamping or turning force to the pliers 1. Grips 10 and 12 may be secured over handles 6 and 8, respectively, where the grips are made of a relatively softer material than the members 2 and 4 to provide a comfortable hand hold.

The opposite end of member 2 from handle 6 is formed as a jaw 14. Likewise the opposite end of member 4 from handle 8 is formed as a jaw 16 that is disposed opposite to jaw 14 such that the jaws can be closed on an article when the handles 6 and 8 are squeezed together. The gripping faces 18 and 20 of jaws 14 and 16 may have any configuration useful for gripping an article.

On member 2 at a location intermediate the handle 6 and jaw 14 is a slotted aperture 22 that receives member 4 as will hereinafter be described. The slotted aperture comprises a first side wall 24 and a second side wall 26 that are spaced to closely receive member 4. The length of aperture 22 is selected to allow the members 2 and 4 to pivot relative to one another between a position where jaws 14 and 16 contact one another and a fully open position. The inside surfaces of walls 24 and 26 are substantially flat to allow the second member to move freely in aperture 22. The side walls 24 and 26 are formed integrally with handle 6 and jaw 14 such that member 2 is of a unitary, single piece construction. Further, aperture 22 is aligned with the longitudinal axis of member 2 such that the width of the pliers is minimized. While in a preferred embodiment the side walls 24 and 26 are formed integrally with handle 6 and jaw 14, either or both of the side walls may be formed as separate components that are secured to handle 6 and jaw 14 by a fastener mechanism such as welding, rivets, threaded fasteners or the like. Even if the side wall 24 and/or 26 are formed as separate components the pliers of the invention have a flat profile because the side walls may be formed as flat members due to the arrangement of the pivot member 28, actuator button 34 and spring 66 as will hereinafter be described. In either embodiment the side walls 24 and 26 do not protrude beyond the extent of the jaws 16 and 14.

Side wall 24 has a through hole 30 formed therein dimensioned to receive one end of pivot member 28. Side wall 26 has a through hole 32 formed therein to receive the opposite end of pivot member 28. The centers of holes 30 and 32 are aligned and define the axis of rotation about which the members 2 and 4 pivot relative to one another during use of the pliers. A well or depression 36 is formed around hole 32 such that the actuator button 34 sits in the well.

Member 4, at a location intermediate of handle 8 and jaw 16, includes an adjustment section 40 that is dimensioned to be received in slotted aperture 22. Adjustment section 40 includes a side face 41 that is substantially flat and is disposed next to the inside surface of wall 24. An elongated through slot 42 is formed in section 40 and extends through member 4 and along the length of member 4 a distance sufficient to allow the adjustment of jaws 14 and 16. The length of slot 42 along its long axis determines the extent of the jaw spacing. On one side of section 4 a row of teeth 45 are formed that extend along the length of slot 42. In the illustrated embodiment two rows of teeth 45 and 47 are used where one row is disposed along each long edge of the slot 42. Teeth 45 and 47 are ratchet teeth that when engaged with teeth formed on pivot member 28 allow the jaws 14 and 16 to move toward one another but prevent the jaws from moving away from one another. Member 4 is dimensioned such that member 4 can be inserted into slotted aperture 22 where slot 42 can be aligned with holes 30 and 32.

The pivoting and adjustment mechanism of the pliers will now be described. Pivot member 28 is inserted through apertures 30 and 32 of member 2 and slot 42 of member 4. Pivot member 28 includes a first substantially round bearing surface 50 that is received in hole 30 and a second substantially round bearing surface 52 that is received in hole 32. Pivot member 28 can rotate relative to member 2 due to the sliding engagement of bearing surfaces 50 and 52 in holes 30 and 32. Pivot member 28 also includes two linear bearing surfaces 54 and 56, positioned between bearing surfaces 50 and 52, that are received in slot 42 of member 4. The linear bearing surfaces 54 and 56 contact the long side edges of slot 42 along a line such that member 4 is prevented from rotating relative to pivot member 28 but member 4 can slide linearly relative to pivot pin 28 due to the sliding engagement of bearing surfaces 50 and 52 with the side edges of slot 42. In other words pivot member 28 and member 4 rotate together as a unit but member 4 can slide linearly relative to pivot member 28 along slot 42.

Bearing surfaces 50 and 52 are dimensioned such that pivot member 28 can move relative to members 2 and 4 transversely to these members along the axis of rotation of members 2 and 4. Pivot member 28 includes a row of ratchet teeth 58 that mate with teeth 45 on member 4. In the illustrated embodiment the pivot member includes a second row of ratchet teeth 60 that mate with teeth 47 on member 4. Pivot member 28 can move transversely between a position where the teeth are engaged to a position where the teeth are disengaged.

The teeth are configured such that when the teeth 58 and 60 on pivot member 28 are engaged with teeth 45 and 47 on member 4, member 4 can slide or ratchet relative to pivot member 28 in a direction that moves jaw 16 toward jaw 14 but member 4 is prevented from moving relative to pivot member 28 in a direction that moves jaw 16 away from jaw 14. The teeth have angled back faces that allow the teeth to ride over one another when the members are moved in a direction that moves the jaws toward one another. As the teeth ride over one another the pivot member 28 is moved slightly against the bias of spring 66 to accommodate this movement. Thus, when pivot member 28 is engaged with member 4 the spacing between the jaws can be quickly narrowed by sliding jaw 16 toward jaw 14. However, the front faces of the teeth are arranged such that the engagement of the teeth prevent the jaws from moving away from one another.

To control the movement of pivot member 28 and the engagement and disengagement of the teeth, a button actuator 34 is connected to pivot member 28. The button actuator 34 and pivot member 28 are fixed to one another such that they move transversely together as a unit. In the illustrated embodiment the button actuator 34 includes a stem 62 that is received in aperture 64 formed in pivot member 28. The stem 62 is permanently connected to pivot member 28 by deformation, a friction fit, mechanical engagement, adhesive, welding or the like. A cap 63 is secured to pivot member 28 to close aperture 64.

A spring 66 exerts a force on button actuator 34 that biases teeth 58 and 60 into engagement with teeth 45 and 47. In the illustrated embodiment, spring 66 is a circular spring such as a multi-turn wave spring disposed around stem 62 before button actuator 34 is connected to pivot member 28 such that the spring 66 is trapped between the well 36 and the head 68 of button 34. Spring 66 exerts a force on head 68 that biases pivot member 28 toward member 4 such that teeth 58 and 60 are biased into engagement with teeth 45 and 47. To disengage teeth 58 and 60 from teeth 45 and 47 the user presses button 34 overcoming the force of spring 66 and moving teeth 58 and 60 away from, and out of engagement with, teeth 45 and 47. In the disengaged position, the member 4 can move relative to pivot member 28 in a direction that moves jaw 16 away from jaw 14. In the disengaged position jaw 16 is also able to move toward jaw 14.

To assemble the pliers 1, member 4 is inserted into slotted aperture 22 and slot 42 is aligned with holes 30 and 32. Pivot member 28 is inserted through aperture 30, slot 42 and aperture 32. Spring 66 is located in well 36 and actuator button 34 is inserted into pivot member 28 to trap spring 66 between actuator button 34 and member 2. Actuator button 34 is fixed to pivot member 28. Cap 63 is inserted into pivot member 28. Grips 10 and 12 can then be secured to handles 6 and 8.

To use the pliers of the invention, the jaws 14 and 16 are separated or brought together distance to accept and grip an article. The jaws 14 and 16 are brought closer together by simply pushing the jaws together. Because the ratchet engagement of teeth 58 and 60 with teeth 45 and 47 allows the jaws to move toward one another, actuator button 34 does not have to be depressed to separate the jaws. To separate the jaws and increase the space between the jaws, the actuator button 34 is depressed to move pivot member away from member 4 and disengage teeth 58 and 60 from teeth 45 and 47. After the teeth are disengaged jaw 16 may be moved away from jaw 14. In the disengaged position jaw 16 may also be moved toward jaw 14. The actuator button 34 is released and the teeth 58 and 60 are again biased into engagement with teeth 45 and 47 to hold the jaw in the selected position. After the jaws are properly adjusted, the handles 6 and 8 can be gripped to manually apply a gripping force to the jaws and a turning force to the pliers

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A pliers comprising:
a first member having a first jaw at one end and a first handle at an opposite end;
a second member having a second jaw at one end and a second handle at an opposite end, said second member pivoting relative to the first member at an axis of rotation;
said first member defining an aperture between the jaw and the handle said aperture being defined by a first side wall and a second side wall where the first side wall, second side wall and handle are integrally formed as a unitary piece;
said first side wall defining a first hole and said second side wall defining a second hole, said first and second holes being aligned along the axis of rotation;
said second member including an elongated slot and a row of teeth, said second member being located in said aperture such that said elongated slot is aligned with said axis of rotation;
a pivot member extending along said axis of rotation and including at least one tooth engagable with said row of teeth such that said at least one tooth is in ratchet engagement with said row of teeth, said pivot member movable between a first position where said at least one tooth engages said row of teeth and movement of the first jaw away from said second jaw is prevented and movement of the first jaw toward said second jaw is allowed; and a second position where said at least one tooth is disengaged from said row of teeth and movement of the first jaw away from second jaw is permitted;
a spring for biasing the pivot member to the first position; and
a manually movable actuator button for moving the pivot member to the second position.

2. The pliers of claim 1 wherein said aperture extends substantially along the longitudinal axis of said first member.

3. The pliers of claim 1 further including a second row of teeth.

4. The pliers of claim 3 wherein said row of teeth and said second row of teeth extend along said elongated slot.

5. The pliers of claim 3 wherein said pivot member includes at least a second ratchet tooth engaging said second row of teeth.

6. The pliers of claim 1 wherein said pivot member and said second member rotate together.

7. The pliers of claim 1 wherein said second member can reciprocate relative to said pivot member.

8. The pliers of claim 1 wherein said pivot member includes a flat bearing surface engaged with said slot to allow the pivot member to slide in said slot and prevent said pivot member from rotating relative to said second member.

9. The pliers of claim 1 wherein said spring is located between said actuator button and said first member.

10. The pliers of claim 1 wherein said actuator button is fixed to said pivot member.

11. A pliers comprising:
a first member having a first jaw at one end and a first handle at an opposite end;
a second member having a second jaw at one end and a second handle at an opposite end, said second member pivoting relative to the first member at an axis of rotation;
said first member defining an aperture between the jaw and the handle said aperture being defined by a first side wall and a second side wall;
said first side wall defining a first hole and said second side wall defining a second hole, said first and second holes being aligned along the axis of rotation;
said second member including an elongated slot and a row of teeth, said second member being located in said aperture such that said elongated slot is aligned with said axis of rotation;
a pivot member inserted into said first hole, said second hole and said slot such that said first member and said second member pivot relative to one another about said pivot member, said pivot member including at least one ratchet tooth engagable with said row of teeth such that said at least one tooth is in ratchet engagement with said row of teeth, said pivot member movable between a first position where said at least one tooth engages said row of teeth and movement of the first jaw away from said second jaw is prevented and movement of the first jaw toward said second jaw is allowed; and a second position where said at least one tooth is disengaged from said row of teeth and movement of the first jaw away from the second jaw is permitted;
a manually movable actuator button for moving the pivot member from the first position to the second position, said actuator button being fixed to said pivot member such that said pivot member and said actuator button move transversely relative to said first member and said second member; and
a spring disposed between said actuator button and said first member for biasing the pivot member to the first position.

12. The pliers of claim 11 wherein said aperture extends substantially along the longitudinal axis of said first member.

13. The pliers of claim 11 further including a second row of teeth.

14. The pliers of claim 13 wherein said row of teeth and said second row of teeth extend along said elongated slot.

15. The pliers of claim 13 wherein said pivot member includes at least a second ratchet tooth engaging said second row of teeth.

16. The pliers of claim 11 wherein said pivot member and said second member rotate together.

17. The pliers of claim 11 wherein said second member can reciprocate relative to said pivot member.

18. The pliers of claim 11 wherein said pivot member includes a flat bearing surface engaged with said slot to allow the pivot member to slide in said slot and prevent said pivot member from rotating relative to said second member.

19. A pliers comprising:
a first member having a first jaw at one end and a first handle at an opposite end;
a second member having a second jaw at one end and a second handle at an opposite end, said second member pivoting relative to the first member at an axis of rotation;
said first member defining an aperture between the jaw and the handle, said aperture being defined by a first side wall and a second side wall where the first side wall, second side wall, the first handle and the first jaw are integrally formed as a unitary piece;
said first side wall defining a first hole and said second side wall defining a second hole, said first and second holes being aligned along the axis of rotation;
said second member including a slot, said second member being located in said aperture such that said slot is aligned with said axis of rotation;
a pivot member inserted into said first hole, said second hole and said slot; said pivot member including a first bearing surface on which said first member rotates and a second bearing surface on which said second member slides; said first member and said second member pivoting relative to one another about said pivot member;
said pivot member movable between a first position where movement of the first jaw away from said second jaw is prevented and movement of the first jaw toward said second jaw is allowed;
and a second position movement of the first jaw away from the second jaw is permitted; and
a manually movable actuator button for moving the pivot member from the first position to the second position, said actuator button being fixed to said pivot member.

20. The pliers of claim 19 wherein said pivot member includes a bearing surface located in said first hole and a bearing surface in said second hole, the engagement of said first bearing surface with said first hole and said second bearing surface with said second hole allows the pivot member to rotate relative to the first member and move transversely relative to the second member.

21. A pliers comprising:
a first member having a first jaw at one end and a first handle at an opposite end;
a second member having a second jaw at one end and a second handle at an opposite end, said second member pivoting relative to the first member at an axis of rotation;
said first member defining an aperture between the jaw and the handle said aperture being defined by a first side wall and a second side wall where the first side wall, second side wall do not extend laterally beyond the width of the jaws;
said first side wall defining a first hole and said second side wall defining a second hole, said first and second holes being aligned along the axis of rotation;
said second member including an elongated slot and a row of teeth, said second member being located in said aperture such that said elongated slot is aligned with said axis of rotation;
a pivot member extending along said axis of rotation and including at least one tooth engagable with said row of teeth such that said at least one tooth is in ratchet engagement with said row of teeth, said pivot member movable between a first position where said at least one tooth engages said row of teeth and movement of the first jaw away from said second jaw is prevented and movement of the first jaw toward said second jaw is allowed; and a second position where said at least one tooth is disengaged from said row of teeth and movement of the first jaw away from second jaw is permitted;
a manually movable actuator button for moving the pivot member to the second position; and
a spring for biasing the pivot member to the first position, said spring located between the one of said first side wall and said second side wall and said actuator button.
